(19) United States
(12) Patent Application Publication
(10) Pub. No.: US 2014/0022636 A1
(43) Pub. Date: Jan. 23, 2014

(54) OPTICAL APPARATUS USED IN 3D IMAGE PICKUP SYSTEM

(71) Applicant: CANON KABUSHIKI KAISHA, Tokyo (JP)

(72) Inventor: Takurou Asano, Kawachi-gun (JP)

(21) Appl. No.: 13/942,888

(22) Filed: Jul. 16, 2013

(30) Foreign Application Priority Data
Jul. 19, 2012 (JP) 2012-160727

(51) Int. Cl. G02B 27/22

(52) U.S. Cl. CPC G02B 27/22
USPC 359/463

(57) ABSTRACT

An apparatus includes first and second lens apparatuses, which have first and second focus lenses, first and second driving units that drive the first and second focus lenses, first and second detectors that detect first and second in-focus information of an object by phase difference detection, and first and second controllers that control driving of the first and second focus lenses. The first controller sets a first target position based on the first in-focus information detected by the first detector and drives the first focus lens. The second controller obtains the first target position or information corresponding to the first target position from the first lens apparatus, sets focus range based on the first target position or the information corresponding to the first target position, and drives the second focus lens based on the focus range and the second in-focus information detected by the second detector.

### BACKGROUND OF THE INVENTION

1. Field of the Invention

The present invention relates to an optical apparatus and more particularly to an optical apparatus used in a 3D imaging.

2. Description of the Related Art

In the imaging industry nowadays, images giving better sense of presence are demanded. In particular, demand for 3D imaging that can present images giving depth feel has been growing greatly. To meet such demand, various apparatuses relating to 3D images, such as 3D image pickup systems picking up two images with a parallax and 3D image display systems, have been invented.

In the 3D image pickup systems, the scheme of using two optical apparatuses arranged in such a way that their optical axes are offset from each other is in the mainstream. This way of arrangement of two apparatuses will sometimes be described as “arranged with parallax”, hereinafter. In such 3D image pickup systems, it is necessary to control the focus positions (or focused distances) of the two optical apparatuses to coincide with each other at all times.

To achieve this, Japanese Patent application Laid-Open No. 2005-173270 teaches to adjust the focus position of one optical apparatus to a focus target position set in the other optical apparatus.

However, in the prior art disclosed in Japanese Patent Application Laid-Open No. 2005-173270, it is assumed that it is possible to cause the focus positions of two optical apparatuses to coincide with each other, and a difference between the focus positions of the two optical apparatuses ascribed to manufacturing error or other factors is not taken into consideration.

Specifically, to cause the focus positions of two optical apparatuses to coincide with each other, data about the distance to an object in focus (which will be hereinafter referred to as the object distance) is exchanged, and control for making the object distances of the two optical apparatuses equal to each other is performed. For instance, let us assume a case where when an object at a distance of 10 meters is in focus, an optical apparatus A determines that the object distance is 9 meters, and the other optical apparatus B determines that the object distance is 11 meters, due to manufacturing errors or for other reasons. In this case, since the optical apparatus B is controlled in such a way as to be focused at the object distance determined by the optical apparatus A, the optical apparatus B is informed by the optical apparatus A of the object distance of 9 meters and controlled in such a way as to be focused at the object distance of 9 meters, coming out of focus consequently.

### SUMMARY OF THE INVENTION

An object of the present invention is to provide an optical apparatus for use in a 3D image pickup system with which two optical apparatuses can be prevented from coming out of focus even if the positions of focus lens are different from each other between two lens apparatuses included in the optical apparatus due to a manufacturing error.

An optical apparatus according to the present invention includes: a first lens apparatus having a first focus lens, a first focus driving unit that drives the first focus lens, a first in-focus state detecting unit that detects first in-focus information of one or more objects by phase difference detection method, and a first focus controller that controls driving of the first focus lens; and a second lens apparatus having a second focus lens, a second focus driving unit that drives the second focus lens, a second in-focus state detecting unit that detects second in-focus information of one or more objects by phase difference detection method, and a second focus controller that controls driving of the second focus lens, wherein in the first lens apparatus, the first focus controller sets a first focus lens target position on the basis of the first in-focus information detected by the first in-focus state detecting unit and drives the first focus lens on the basis of the first focus lens target position, and in the second lens apparatus, the second focus controller obtains the first focus lens target position or information corresponding to the first focus lens target position from the first lens apparatus, sets a focus range on the basis of the first focus lens target position or the information corresponding to the first focus lens target position, and drives the second focus lens on the basis of the focus range and the second in-focus information detected by the second in-focus state detecting unit.

An optical apparatus according to another aspect of the present invention includes: a first lens apparatus having a first focus lens, a first focus driving unit that drives the first focus lens, a first in-focus state detecting unit that detects first in-focus information of one or more objects, and a first focus controller that controls driving of the first focus lens; and a second lens apparatus having a second focus lens, a second focus driving unit that drives the second focus lens, a second in-focus state detecting unit that detects second in-focus information of one or more objects, and a second focus controller that controls driving of the second focus lens, wherein in the first lens apparatus, the first focus controller drives the first focus lens on the basis of a given first focus lens target position, and in the second lens apparatus, the second focus controller obtains, from the first lens apparatus, the first in-focus information detected by the first in-focus state detecting unit and a first focus lens reference position based on the first focus lens target position or information corresponding to the first focus lens reference position, sets a focus range on the basis of the first focus lens reference position or the information corresponding to the first focus lens reference position, and drives the second focus lens on the basis of the focus range, the second in-focus information detected by the second in-focus state detecting unit, and the defocus amount.

In an optical apparatus for use in a 3D image pickup system, the present invention can prevent two optical apparatuses from coming out of focus even if the positions of focus lens are different from each other between two lens apparatuses included in the optical apparatus due to a manufacturing error.

Further features of the present invention will become apparent from the following description of exemplary embodiments with reference to the attached drawings.

### BRIEF DESCRIPTION OF THE DRAWINGS

FIG. 1 is a block diagram illustrating the configuration of a 3D image pickup system according to a first embodiment.

FIG. 2 illustrates a horizontal in-focus focus lens position detection area in the picked-up image frame.

FIG. 3 illustrates a vertical in-focus focus lens position detection area in the picked-up image frame.

FIG. 4 is a flow chart of a process for detecting an in-focus focus lens position.

FIG. 5 illustrates a method of calculating a phase difference amount.

FIG. 6 is a flow chart of a software process performed in a CPU 113 in the first embodiment.

FIG. 7 is a table showing data communicated in the first embodiment.

FIG. 8 is a flow chart of a software process performed in a CPU 213 in the first embodiment.

FIG. 9 is a flow chart of a focus lens target position calculation process 1.

FIG. 10 illustrates a focusing operation in the first embodiment.

FIG. 11 is a block diagram illustrating the configuration of a 3D image pickup system according to a second embodiment.

FIG. 12 is a flow chart of a software process performed in a CPU 113 in the second embodiment.

FIG. 13 is a table illustrating data communicated in the second embodiment.

FIG. 14 is a flow chart of a software process performed in a CPU 213 in the second embodiment.

FIG. 15 is a flow chart of a focus lens target position calculation process 2.

FIG. 16 illustrates a focusing operation in the second embodiment.

### DESCRIPTION OF THE EMBODIMENTS

Preferred embodiments of the present invention will now be described in detail in accordance with the accompanying drawings.

### First Embodiment

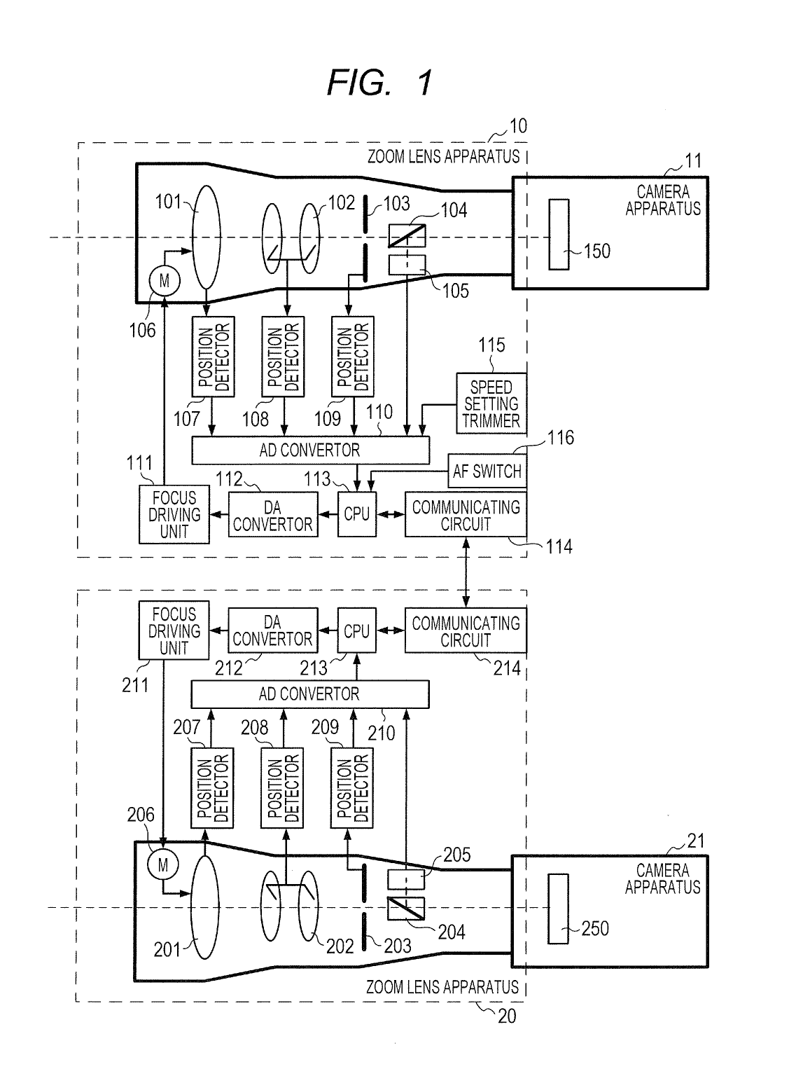

FIG. 1 shows the configuration of a 3D image pickup system according to a first embodiment to which the present invention can be applied. The 3D image pickup system according to the present invention includes two image pickup apparatuses that exchange signals with each other. Each image pickup apparatus includes a zoom lens apparatus and a camera apparatus that receives object light having passed through the zoom lens apparatus.

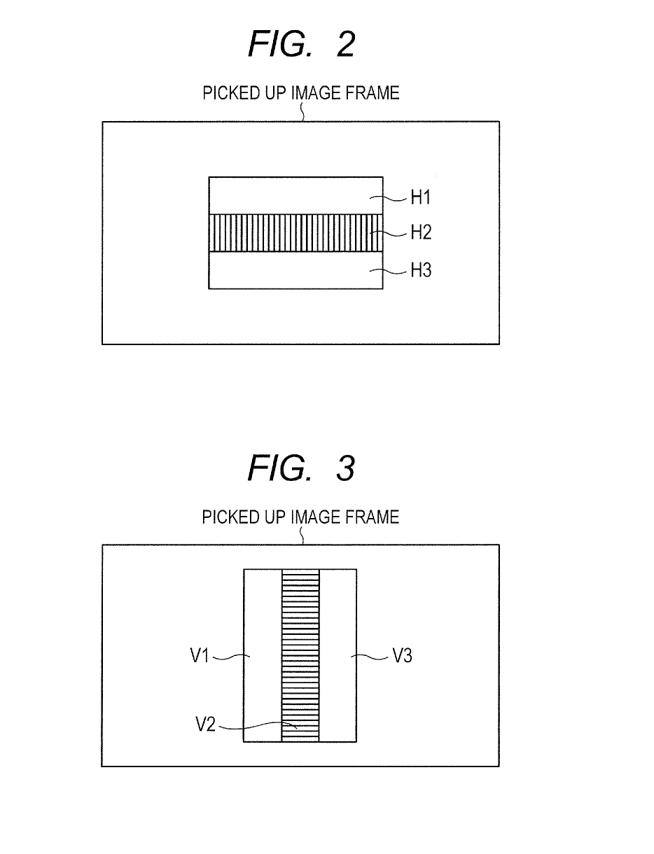

Firstly, the zoom lens apparatus 10 (the first lens apparatus) will be described. A focus lens unit 101 (the first focus lens) is an optical component adapted move in the direction of the optical axis to shift the imaging position of the zoom lens apparatus 10. A zoom lens unit 102 is an optical component adapted to move in the direction of the optical axis to thereby vary the focal length of the zoom lens apparatus 10. A stop 103 is a member used to control the light quantity of the beams passing through the zoom lens apparatus 10. A half mirror 104 is an optical component used to split the incident beams into beams to be incident on a CCD 150 and beams to be incident on a phase difference sensor 105. The phase difference sensor 105 extracts two beams symmetrical with respect to the optical axis from among the beams incident thereon from the half mirror 104, focuses the two beams onto different photoelectric transducer arrays (which will be hereinafter referred to as the “pixel arrays”) respectively, and generates electrical signals representing the light quantities obtained from the respective pixel arrays. In this embodiment, there are six pairs of pixel arrays in total. As shown in FIGS. 2 and 3, there is a pixel array made up of a plurality of pixels is arranged in each of areas H1 to H3 and areas V1 to V3 in the image pickup area. A focus motor 106 (the first focus driving unit) is a motor for driving the focus lens unit 101. The focus motor 106 is driven based on a control signal generated by a CPU 113 (the first focus controller) through a DA converter 112 and a focus driving circuit 111. Position detectors 107 to 109 are detectors that detect the positions of the focus lens unit 101, the zoom lens unit 102, and the stop 103 respectively and generate position signals. The position signals thus generated are input to the CPU 113 via an AD converter 110. The CPU 113 generates a focus control signal and communicates with a CPU 213 by later-described processing. A communicating circuit 114 is a circuit used to communicate with a zoom lens apparatus 20. A speed setting trimmer 115 is a trimmer used to adjust the driving speed of the focus lens. A signal generated by the speed setting trimmer 115 is input to the CPU 113 via the AD converter 110. An AF switch 116 is a push switch used to activate the auto-focus operation.

The constituents 201 to 214 of the zoom lens apparatus 20, which is the second lens apparatus, such as a focus lens unit 201 (the second focus lens), a focus motor 206 (the second focus driving unit), and the CPU 213 as the second focus controller, have the same functions as those of the constituents 101 to 114 of the zoom lens apparatus 10. Therefore, they will not be described further.

Next, a process for detecting an in-focus focus lens position, which is performed in the same manner in both the CPU 113 (the first in-focus distance detecting unit) of the zoom lens apparatus 10 and the CPU 213 (the second in-focus distance detecting unit) of the zoom lens apparatus 20, will be described.

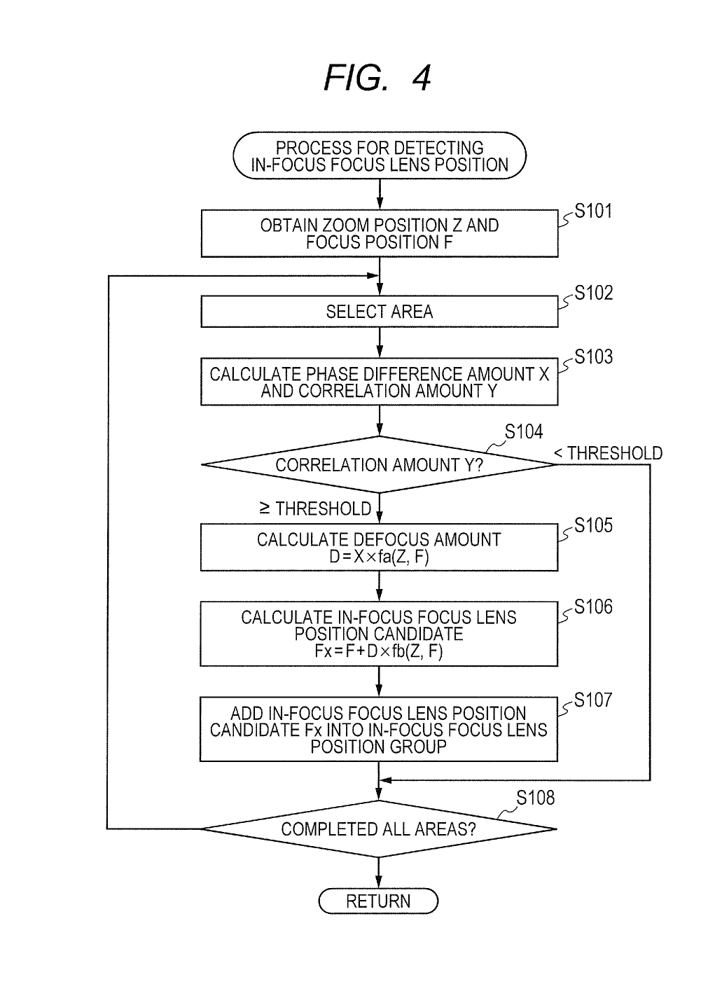

FIG. 4 is a flow chart of the process for detecting an in-focus focus lens position. Here, the process for detecting an in-focus focus lens position performed in the zoom lens apparatus 10 will be described. The same process is performed also in the other lens apparatus 20.

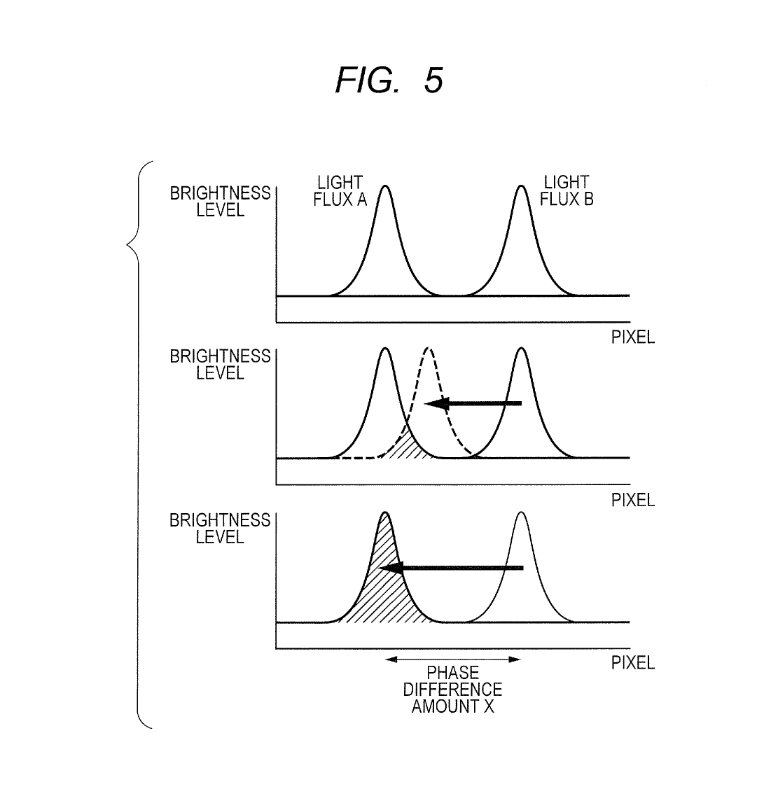

In step S101, position data of the focus lens unit (which will be hereinafter referred to as the focus position) F and position data of the zoom lens unit (which will be hereinafter referred to as zoom position) Z are obtained from the position detectors 107, 108 via the AD converter 110. In step S102, one of the areas H1 to H3 and the areas V1 to V3 shown in FIGS. 2 and 3 is selected. In Step S103, a phase difference amount in the selected area is calculated. The method of obtaining the phase difference amount is a common correlation calculation, which is specifically illustrated in FIG. 5. As shown in FIG. 5, a waveform is virtually shifted by digital processing, and a shift amount at which the best coincidence between the waveforms is achieved is set as the phase difference amount X. In this embodiment, the area obtained as the AND (logical product) of the luminance level waveforms at the shift amount at which the best coincidence between the waveforms is calculated as a correlation amount Y, which is used as a value representing the reliability of the phase difference amount X. In step S104, a determination is made as to whether or not the correlation amount Y calculated in step S103 is equal to or larger than a predetermined threshold. If the correlation amount Y is equal to or larger than the threshold, the process proceeds to step S105. If the correlation amount Y is smaller than the threshold, the process proceeds to step S108.

In Step S105, a defocus amount D is calculated from the phase difference amount X, the zoom position Z, and the focus position F according to the following equation:

D=X×fa(Z,F),

where the function fa(Z, F) is a function of the zoom position Z and the focus position F, which uses a lookup table and is specific to each zoom lens apparatus. In the zoom lens apparatus 10, the defocus amount D is calculated by fa1(Z, F), and in the zoom lens apparatus 20, the defocus amount D is calculated by fa2(Z, F).

In step S106, an in-focus focus lens position candidate Fx is calculated from the defocus amount D, the zoom position Z, and the focus position F according to the following equation:

Fx=F+D×fb(Z,F),

where the function fb(Z, F) is a function of the zoom position Z and the focus position F, which uses a lookup table and is specific to each zoom lens apparatus. While a function fb1(Z, F) is used in the calculation in the zoom lens apparatus 10, another function fb2(Z, F) is used in the calculation in the zoom lens apparatus 20.

In step S107, the in-focus focus lens position candidate Fx calculated in step S106 is added into an in-focus focus lens position group Fx[N] (focus information), and then the process proceeds to step S108. In step S108, a determination is made as to whether the processing of steps S102 to S107 has been performed for all of the six areas shown in FIGS. 2 and 3. If the process has been performed for all the area, the process for detecting an in-focus focus lens position is terminated.

Next, a software process performed in the CPU 113 of the zoom lens apparatus 10 will be described.

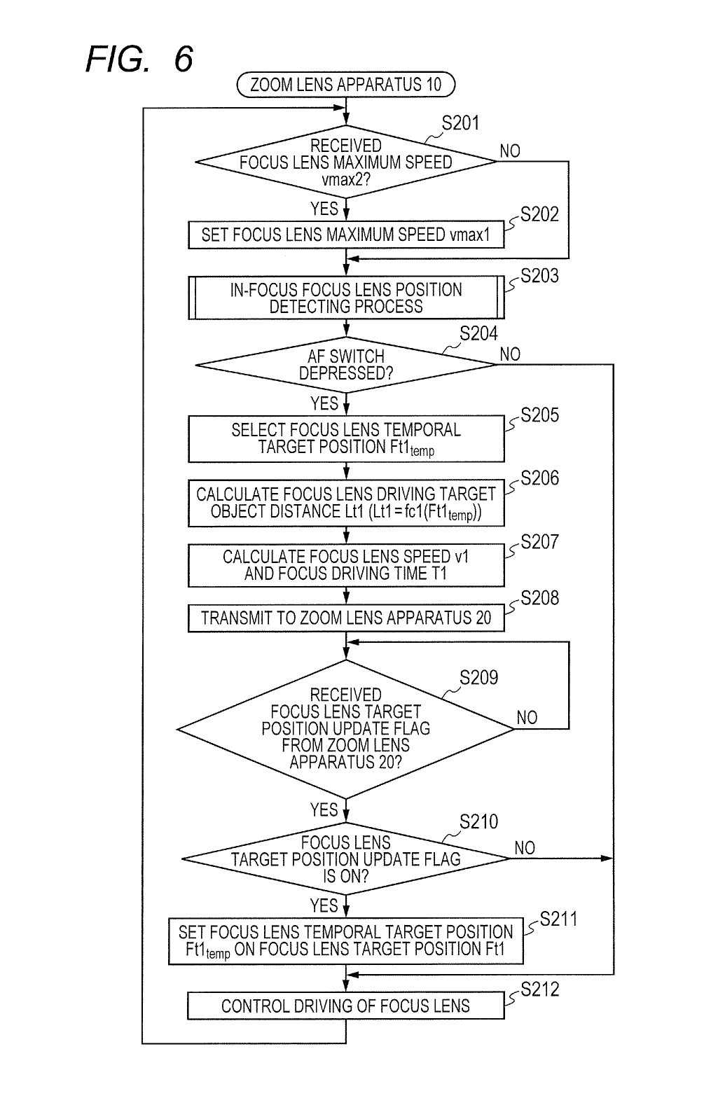

FIG. 6 is a flow chart of the software process performed in the CPU 113 in the first embodiment. In step S201, a determination is made as to whether or not the value of the maximum speed vmax2 at which the zoom lens apparatus 20 can drive the focus lens has been received from the zoom lens apparatus 20. If the value of the maximum focus lens speed vmax2 has been received, the process proceeds to step S202, where the maximum speed vmax1 of the focus lens in the zoom lens apparatus 10 is calculated and stored in a memory in the CPU 113. The maximum focus lens speed vmax1 of the master zoom lens apparatus 10 is set to be lower than the maximum focus lens speed vmax2 of the slave zoom lens apparatus 20 so as to prevent a situation in which the focus driving in the zoom lens apparatus 20 cannot catch up with the focus driving in the zoom lens apparatus 10 from occurring. This enables the zoom lens apparatuses 10 and 20 to drive the respective focus lenses at the same speed.

In step S203, an in-focus focus lens position detecting process is performed. The in-focus focus lens position detecting process is the process described with reference to the flow chart of FIG. 4, in which a group Fx1[N] of a plurality of in-focus focus lens positions, which is a array of focus lens positions (the first in-focus information) corresponding to the object distances of one or more detected objects, is obtained by calculation.

In step S204, a determination is made as to whether or not the AF switch 116 is depressed. If the AF switch is depressed, the process proceeds to step S205. If the AF switch is not depressed, the process proceeds to step S212. In step S205, a position Ft1ₜₑₘₚ that can be a target of driving of the focus lens (which will be hereinafter referred to as the “focus lens temporal target position”) is selected from among the group Fx1[N] of a plurality of in-focus focus lens positions obtained by calculation in step S203. In this embodiment, the closest position in the in-focus focus lens position group Fx1[N] is selected. However, the position to be selected is not limited to this, but the position that gives the largest correlation amount or the position nearest to the present focus position may be selected.

Then, in step S206, an object distance Lt1 corresponding to the focus lens temporal target position Ft1ₜₑₘₚ (the information corresponding to the first focus lens target position) is calculated by the following equation:

Lt1=fc1(Ft1ₜₑₘₚ),

where the function fc1(Ft1ₜₑₘₚ) is a function of Ft1ₜₑₘₚ, which uses a lookup table.

In step S207, a focus lens driving speed v1 and a focus driving time T1 are calculated. The focus lens driving speed v1 is calculated based on a signal from the speed setting trimmer 115 and the maximum focus lens speed vmax1 calculated in step S202 and limited to a value not higher than Vmax1. The focus driving time T1 is calculated using the present focus lens position F1, the focus lens temporal target position Ft1ₜₑₘₚ, and the focus lens driving speed v1.

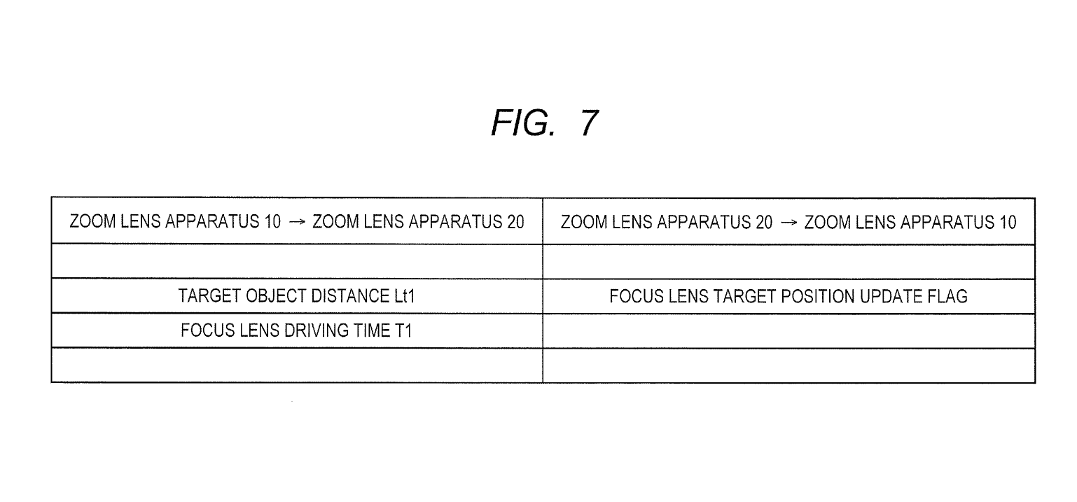

In step S208, the data obtained by the above-described processes is transmitted to the zoom lens apparatus 20. In step S209, the process waits until a reply from the zoom lens 20 is received. In this embodiment, the data described in FIG. 7 is communicated in steps S208 and S209. The focus lens target position update flag referred to in FIG. 7 is a flag indicating whether or not to update a position serving as the target of focus lens driving (which will be hereinafter referred to as the focus lens target position). If a replay from the zoom lens apparatus 20 is received in step S209, the process proceeds to step S210, and only if the focus lens target position update flag is ON, the focus lens temporal target position Ft1ₜₑₘₚ is set as the focus lens target position Ft1 (the first focus lens target position) in step S211. Then, in step S212, a focus control signal is generated based on the focus lens target position Ft1, the present focus lens position F1, and the focus lens driving speed v1 and transmitted to the focus driving circuit 111 via the DA converter 112.

Then, the process returns to step S201, and the same process is performed repeatedly.

Next, a software process performed in the CPU 213 of the zoom lens apparatus 20 will be described in the following.

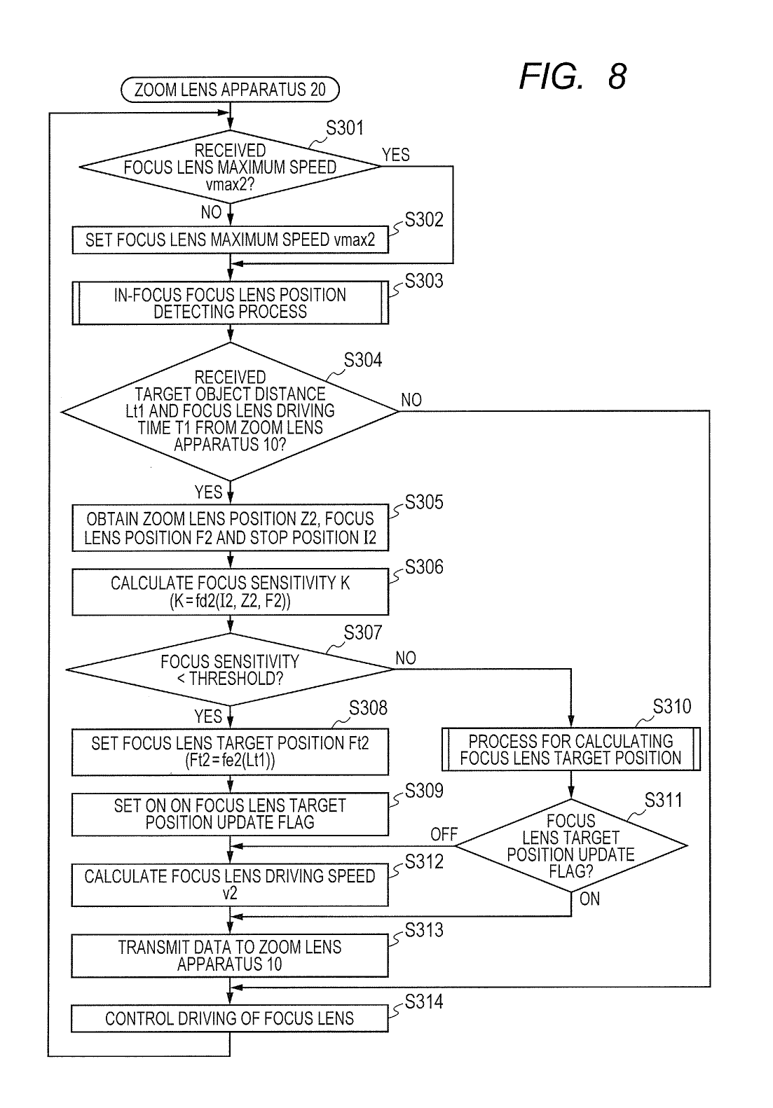

FIG. 8 is a flow chart of the software process performed in the CPU 213 in the first embodiment.

In step S301, a determination is made as to whether or not the value of the maximum focus lens speed vmax2 of the zoom lens apparatus 20 has been sent to the zoom lens apparatus 10. If the value of the maximum focus lens speed has not been sent, the value of the maximum focus lens speed vmax2 is sent to the zoom lens apparatus 10 in step S302. In step S303, the in-focus focus lens position detecting process described with reference to the flow chart of FIG. 4 is performed to obtain an in-focus focus lens position group Fx2[N] (the second in-focus information) by calculation. In step S304, a determination is made as to whether or not the data described in FIG. 7 has been received from the zoom lens apparatus 10. If the data has not been received, the process proceeds to step S314. If the data has been received, the process proceeds to step S305.

In step S305, the zoom lens position Z2, the focus lens position F2, and the stop position I2 are obtained from the position detectors 207 to 209 via the AD converter 210. In step S306, the CPU 213, which also serves as a focus sensitivity calculating unit, calculates a focus sensitivity K, which is a value representing the out-of-focus amount resulting from a predetermined amount of deviation of the focus lens position. The focus sensitivity K indicates the likelihood that an out-of-focus state resulting from a deviation of the focus lens position from the in-focus position is recognized. The larger the focus sensitivity K is, the more likely the out-of-focus state is recognized, and the more accurate focus adjustment is needed. The focus sensitivity K is calculated based on the zoom lens position (the position of the zoom lens) Z2, the focus lens position (the position of the focus lens) F2, and the stop position I2, according to the following equation:

K=fd2(I2,Z2,F2),

where the function fd2(I2, Z2, F2) is a function using a lookup table with which the focus sensitivity K is calculated from the zoom lens position Z2, the focus lens position F2, and the stop position I2.

In step S307, a determination is made as to whether or not the focus sensitivity K calculated in step S306 is smaller than a predetermined threshold. If the focus sensitivity K is smaller than the threshold, the process proceeds to step S308. If the focus sensitivity is not smaller than the threshold, the process proceeds to step S310.

In step S308, the focus lens target object distance Lt1 (the information corresponding to the first focus lens target position) received from the zoom lens apparatus 10 is converted to a focus lens position in the zoom lens apparatus 20 by the following equation, and the position after conversion is set as a focus lens target position Ft2 (the second focus lens target position):

Ft2=fe2(Lt1),

where the function fe(Lt1) is a function using a lookup table for calculating the position of the focus lens in the zoom lens apparatus 20 from the focus lens target object distance Lt1 and converts an object distance to a position of the focus lens. Then, the process proceeds to step S309, where the focus lens target position update flag is set ON, because the focus lens target position Ft2 has been updated, and thereafter the process proceeds to step S312.

On the other hand, in step S310, which is executed in the case where it is determined in step S307 that the focus sensitivity K is not smaller than the threshold, a later described process for calculating a focus lens target position (focus lens target position calculating process 1) is performed, in which a focus lens target position Ft2 is calculated and the focus lens target position update flag is set. In step S311, a determination is made as whether or not the focus lens target position update flag is ON. If the focus lens target position update flag is ON, the process proceeds to step S312. If the focus lens target position update flag is not ON, the process proceeds to step S313.

In step S312, a focus lens driving speed v2 is calculated from the present focus lens position F2, the focus lens target position Ft2 (the second focus lens target position), and the focus lens driving time T1 received from the zoom lens apparatus 10. By calculating the focus lens driving speed v2 in this way, the zoom lens apparatus 10 and the zoom lens apparatus 20 will be controlled to attain the focus lens target position Ft1 (the first focus lens target position) and the focus lens target position Ft2 (the second focus lens target position) respectively at the same time, providing a natural 3D image with which a viewer does not feel anything strange. In this embodiment, the focus lens driving speed is calculated from the driving time, which is calculated precisely. However, the focus lens driving speeds of the zoom lens apparatus 10 and the zoom lens apparatus 20 may be matched by simply exchanging the values of the focus lens driving speeds.

In step S313, a focus lens target position update flag is transmitted to the zoom lens apparatus 10. Then, in step S314, a focus control signal is generated based on the present focus lens position F2, the focus lens target position Ft2, and the focus lens driving speed v2 and transmitted to the focus driving circuit 211 via the DA converter 212. Then, the process returns to step S301, and the same process is performed repeatedly.

In the software process performed in the CPU 213, in conditions in which the focus sensitivity K is low, the position of the focus lens in the zoom lens apparatus 20 is simply set to the position of the focus lens corresponding to the object distance of the zoom lens apparatus 10. This is because when the focus sensitivity is low, an out-of-focus state resulting from an error in the object distance has little effects. The above process can lead to a further reduction in the processing load.

Next, the focus lens target position calculating process 1 in step S310 will be described in detail.

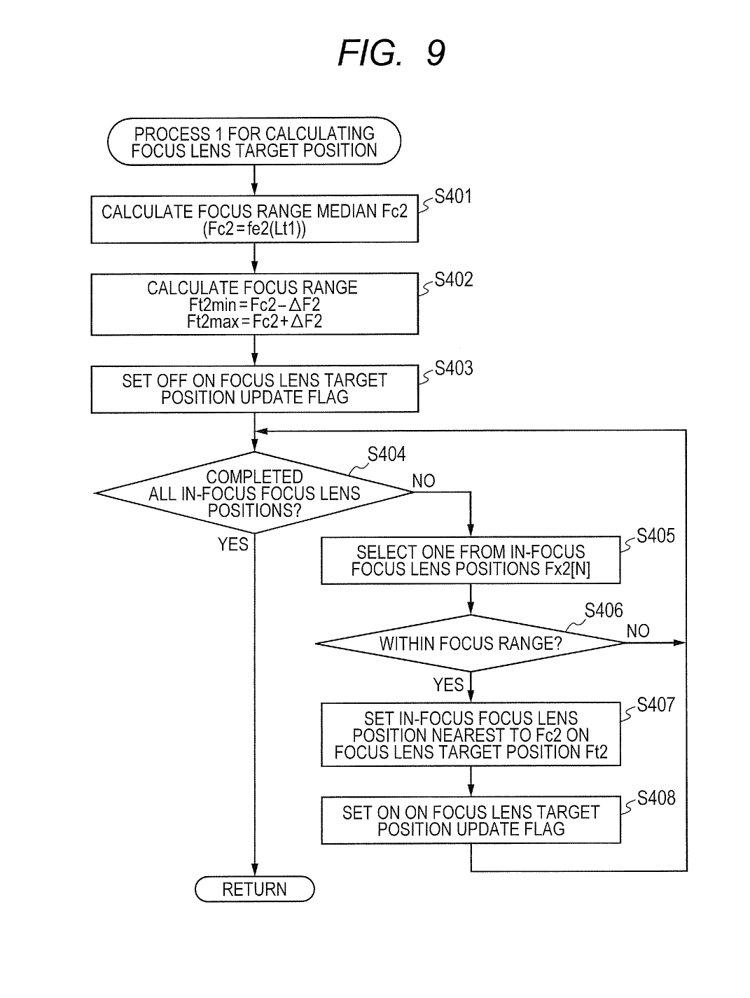

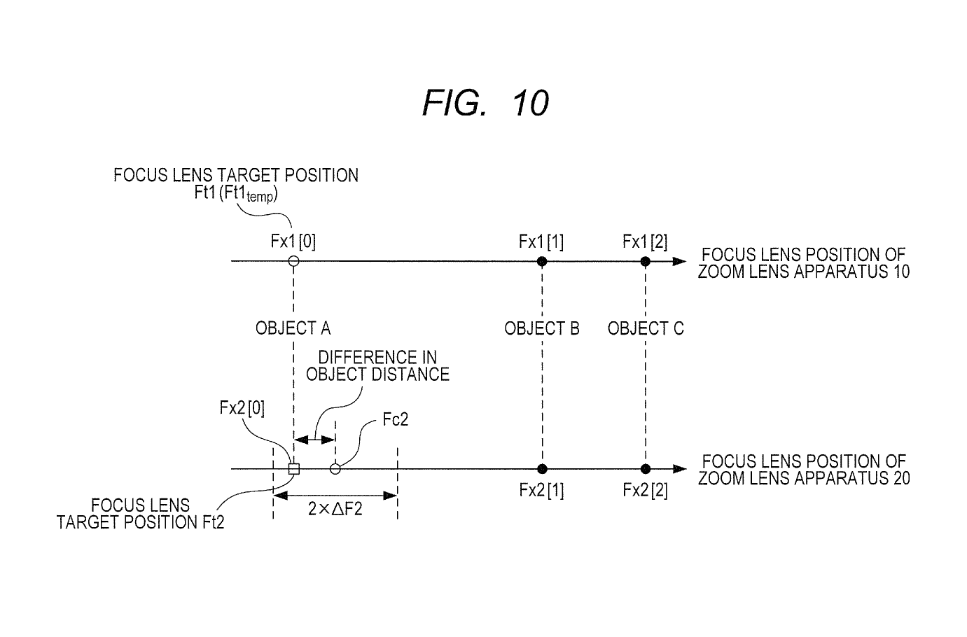

FIG. 9 is a flow chart of the focus lens target position calculating process 1.

In step S401, the focus lens target object distance Lt1 (the information corresponding to the first focus lens target position) of the zoom lens apparatus 10 is converted to a position of the focus lens by calculation using the lookup table fe2(x) used in step S308 according to the following equation:

Fc2=fe2(Lt1),

and the value thus obtained is set as a focus range median Fc2.

In step S402, the smallest value Ft2min and the largest value Ft2max of a focus range having the focus range median Fc2 at its center are calculated by the following equations:

Ft2min=Fc2−ΔF2, and

Ft2max=Fc2+ΔF2,

where ΔF2 is the width of the focus range (focus range width) representing an in-focus range. It is desirable that the focus range width ΔF2 be set to be equal to a difference in the focus position corresponding to the maximum difference between the object distances estimated by the two zoom lens apparatuses 10 and 20 respectively by ranging the same object. In this embodiment, a width stored beforehand is set as the focus range width ΔF2. However, the focus range width ΔF2 may be adapted to be adjusted by an operator or varied in relation to the zoom lens position Z2, the focus lens position F2, and the stop position I2.

In step S403, the focus lens target position update flag is set to OFF. In step S404, a determination is made as to whether or not the process of steps S405 to S406 has been performed for all of the in-focus focus lens positions in the group Fx2[N] (the second in-focus information) obtained by calculation in step S303. If the process has been performed for all of the in-focus focus lens positions, or if there is no in-focus focus lens position in the in-focus focus lens position group Fx2[N], the focus lens target position calculating process 1 is terminated.

In step S405, one in-focus focus lens position is selected from the in-focus focus lens position group Fx2[N]. In step S406, a determination is made as to whether or not the selected in-focus focus lens position falls within the focus range calculated in step S402. If the selected in-focus focus lens position falls out of the focus range, the process returns to step S404. If the selected in-focus focus lens position falls within the focus range, the process proceeds to step S407. In step S407, the in-focus focus lens position nearest to the focus range median Fc2 among the in-focus focus lens positions in the focus range is set as a focus lens target position Ft2 (the second focus lens target position). If there is only one in-focus focus lens position in the focus range, this in-focus focus lens position is set as the focus lens target position Ft2. In step S408, the focus lens target position update flag is set to ON, because the focus lens target position has been updated. Then, the process returns to step S404. By performing the focus lens target position calculating process 1, the focus lens target position Ft2 is set to position selected from the in-focus focus lens position group Fx2[N]. Therefore, an out-of-focus state resulting from an error in the focus position can be prevented from occurring.

The operation and advantageous effects of the apparatus according to the embodiment will be specifically described with reference to FIG. 10. It is assumed here that the zoom lens apparatuses 10, 20 are taking an image of three objects, which are referred to as object A, object B, and object C in order from the shorter object distance, the object A being the closest. It is also assumed that there is a difference between the object distance estimated by the zoom lens apparatus 10 and the object distance estimated by the zoom lens apparatus 20. Firstly, the in-focus focus lens position detecting process shown in FIG. 4 (step S203 in FIG. 6) is performed to obtain three in-focus focus lens positions Fx1[0], Fx1[1], Fx1[2] (the first in-focus information). The closest in-focus focus lens position Fx1[0] among these positions is set as a focus lens temporal target position Ft1ₜₑₘₚ (S205), and a value Lt1 converted into an object distance (the information corresponding to the first focus lens target position) is transmitted to the zoom lens apparatus 20 (S208). In the zoon lens apparatus 20, the object distance Lt1 thus received (S304) is converted into a position of the focus lens to obtain a focus range median Fc2 (S401). At this time, there is a difference between the object distance estimated by the zoom lens apparatus 10 and the object distance estimated by the zoom lens apparatus 20. Therefore, if the focus lens is controlled to be driven to the position Fc2, an out-of-focus state will result. In this embodiment, the in-focus focus lens position Fx2[0] detected by the zoom lens apparatus 20 within the range of ±ΔF2 from the focus range median Fc2 (or within the focus range) is set as a focus lens target position Ft2 (S407). In consequence, an in-focus state is achieved, even though there is a difference between the object distance estimated by the zoom lens apparatus 10 and the object distance estimated by the zoom lens apparatus 20.

As described above, even when there is a difference between the object distances estimated respectively by two zoom lens apparatuses, both the apparatuses can perform accurate focusing operations. Moreover, since in-focus focus lens position information greatly deviating from the object distance in one zoom lens apparatus is ignored, a situation in which the object distances in the two zoom lens apparatuses are deviated from each other can be prevented from occurring. Furthermore, since in this process, the time at which an in-focus state is achieved and the focusing speed are the same between the two zoom lens apparatuses, a natural 3D image with which a viewer does not feel anything strange can be picked up.

### Second Embodiment

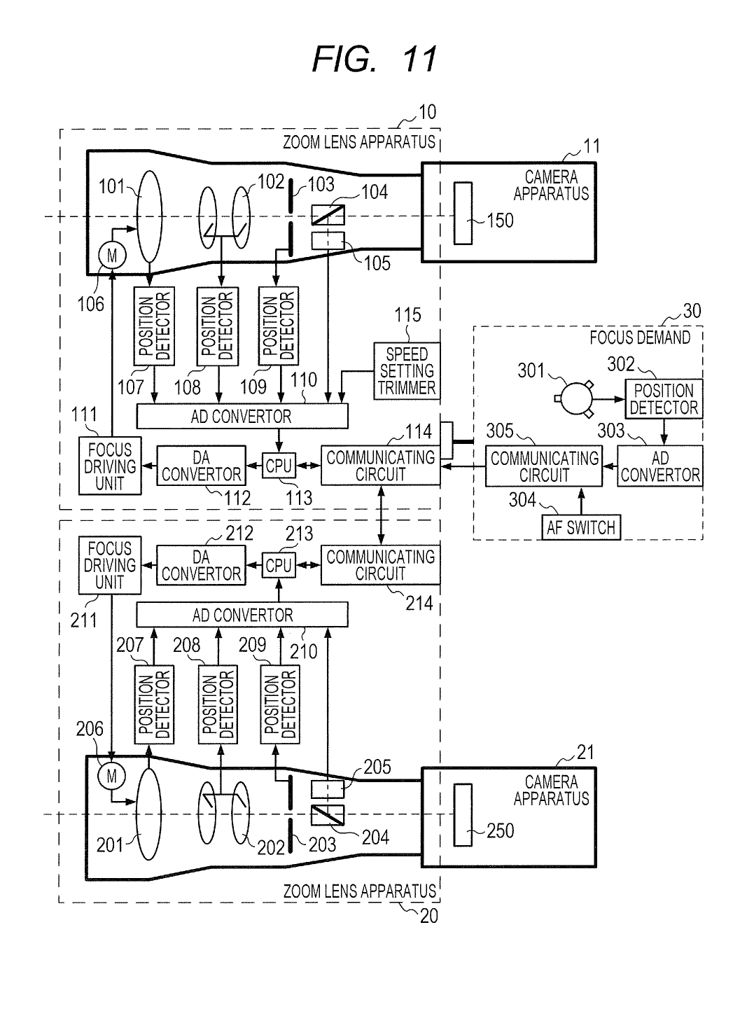

FIG. 11 shows the configuration of a 3D image pickup system according to a second embodiment to which the present invention can be applied.

Components same as those in the first embodiment will not be described, and a focus demand 30, which the 3D image pickup system according to the first embodiment does not have, will be described. A focus operating member 301 is a rotational operating member used to operate (or change) focus. The rotational position of the focus operating member 301 is converted into focus operation position data by a position detector 302 and an AD converter 303 and transmitted to the zoom lens apparatus 10 by a communication circuit 305. An AF switch 304 is a push switch used to activate auto focusing operation.

Next, a software process performed in the CPU 113 in the zoom lens apparatus 10 will be described.

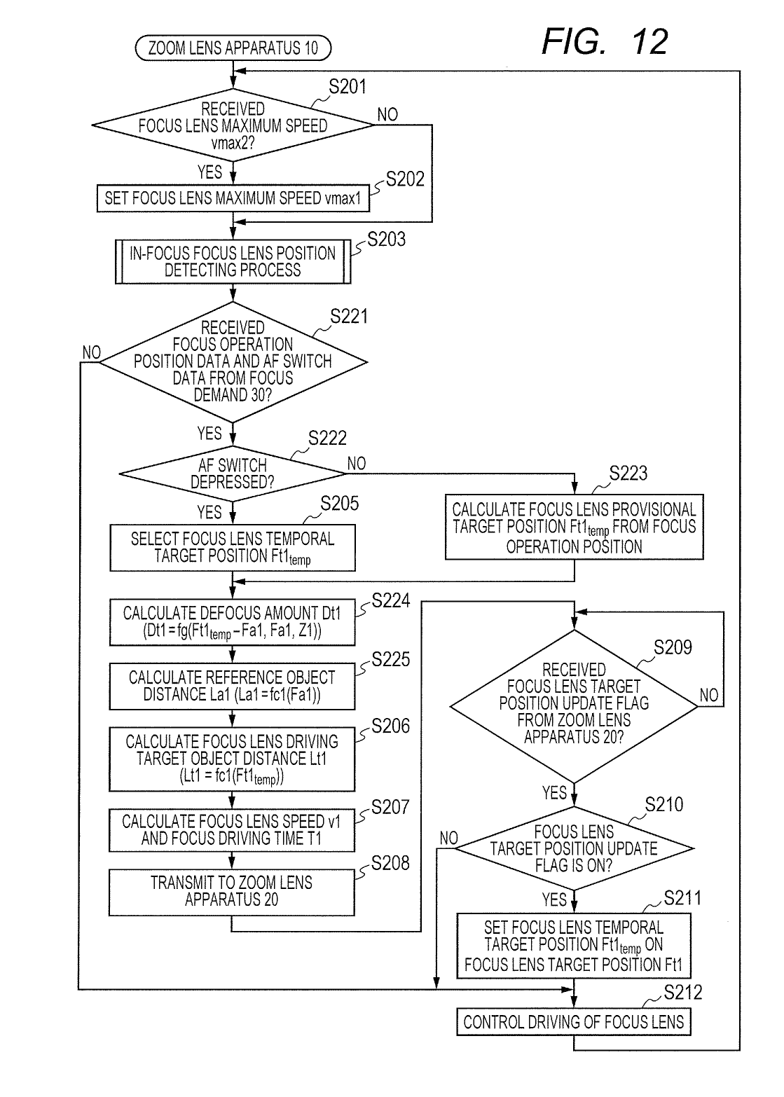

FIG. 12 is a flow chart of the software process performed in the CPU 113 in the second embodiment.

Steps S201 to S203 are the same as those in the first embodiment. In steps S201 to S203, the maximum focus lens speed vmax1 is set, and the in-focus focus lens position group Fx1[n] (the first in-focus information) is obtained. In step S221, a determination is made as to whether or not data is received from the focus demand 30. The received data mentioned here includes data of the focus operation position of the focus operating member 301 and data indicating whether or not AF switch 304 is depressed. If the data was received, the process proceeds to step S222. If the data was not received, the process proceeds to step S212.

In step S222, a determination is made as to whether or not the AF switch 304 was depressed. If the AF switch 304 is depressed, the process proceeds to step S205, where a focus lens temporal target position Ft1ₜₑₘₚ is selected from the in-focus focus lens position group Fx1[n] (the first in-focus information), as with in the first embodiment. On the other hand, if the AF switch 304 was not depressed, the process proceeds to step S223, where a focus lens temporal target position Ft1ₜₑₘₚ is calculated from the focus operation position data received from the focus demand 30. In step S224, the defocus amount Dt1 between the focus lens temporal target position Ft1ₜₑₘₚ obtained in step S223 or S205 and the in-focus focus lens position nearest to that position (which will be hereinafter referred to as the focus lens reference position) Fa1 is calculated by the following equation:

Dt1=fg(Ft1ₜₑₘₚ−Fa1,Fa1,Z1),

where fg(Ft1ₜₑₘₚ−Fa1, Fa1, Z1) is a function of the focus lens reference position Fa1 (the first focus lens reference position), the focus lens temporal target position Ft1ₜₑₘₚ, and the zoom position Z1, which uses a lookup table.

In step S225, a reference object distance La1 (the information corresponding to the first focus lens reference position), which is the object distance at the focus lens reference position Fa1, is calculated by calculation using the lookup table fc1(x) used in step S206 in the first embodiment according to the following equation:

La1=fc1(Fa1).

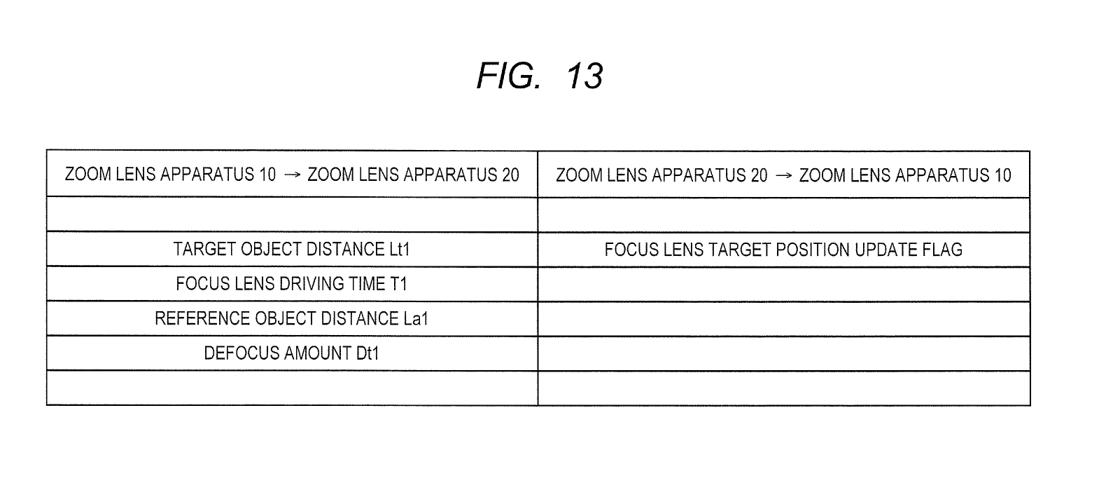

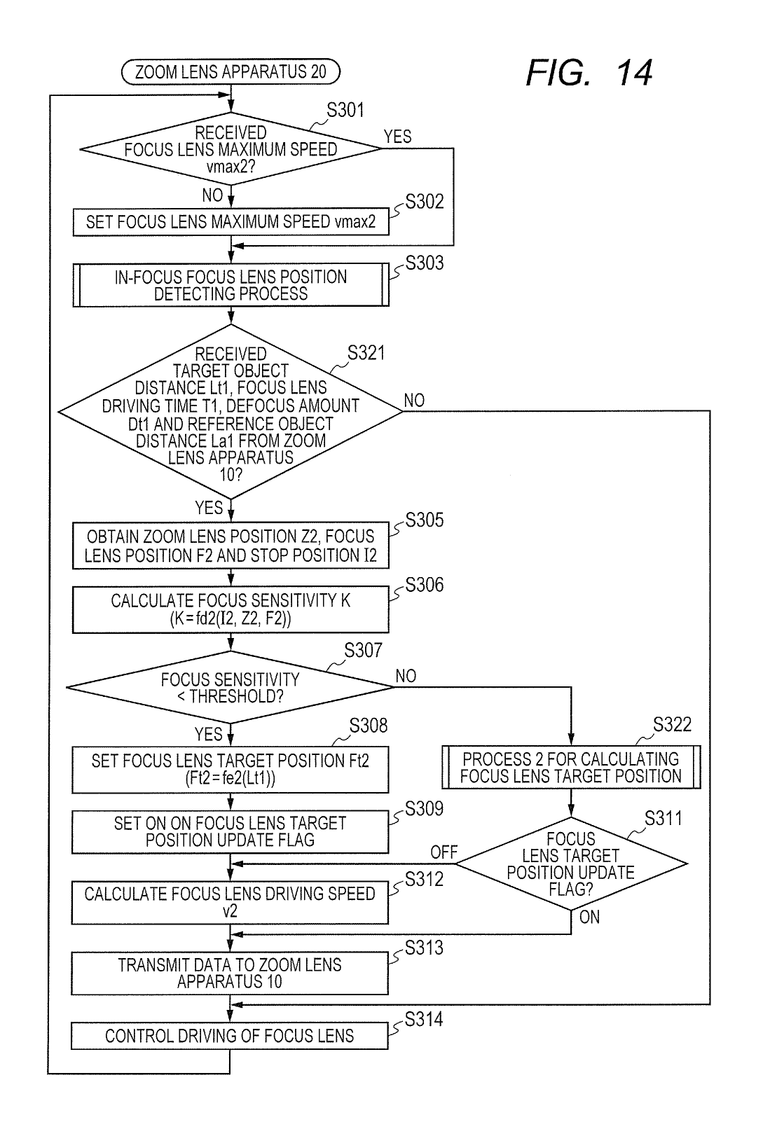

In the case where the focus lens temporal target position Ft1ₜₑₘₚ is one calculated in step S205, the position Ft1ₜₑₘₚ is identical to one of the in-focus focus lens positions in the in-focus focus lens position group Fx1[N] (the first in-focus information), and Ft1ₜₑₘₚ and Fa1 are equal to each other, necessarily making the value of Dt1 equal to 0. The process in steps S206 to S212 is substantially the same as that in the first embodiment and will not be described in further detail. What is different in this process from the first embodiment is that in the process of transmission to the zoom lens apparatus 20 performed in step S208, the defocus amount Dt1 and the reference object distance La1 are also transmitted in addition to the target object distance Lt1 and the focus driving time T1, as shown in FIG. 13.

Next, a software process performed in the CPU 213 of the zoom lens apparatus 20 will be described.

FIG. 14 is a flow chart of the software process performed in the CPU 213 in the second embodiment.

Because what is different in flow chart of FIG. 14 from the flow chart of FIG. 8 is only that the data received in step S321 additionally includes the defocus amount Dt1 and the reference object distance La1 and that the process for calculating a focus lens target position in step S322 is different from that in FIG. 8, the description of the flow chart of FIG. 14 will not be made.

The focus lens target position calculation process 2 performed in step S322 will be described.

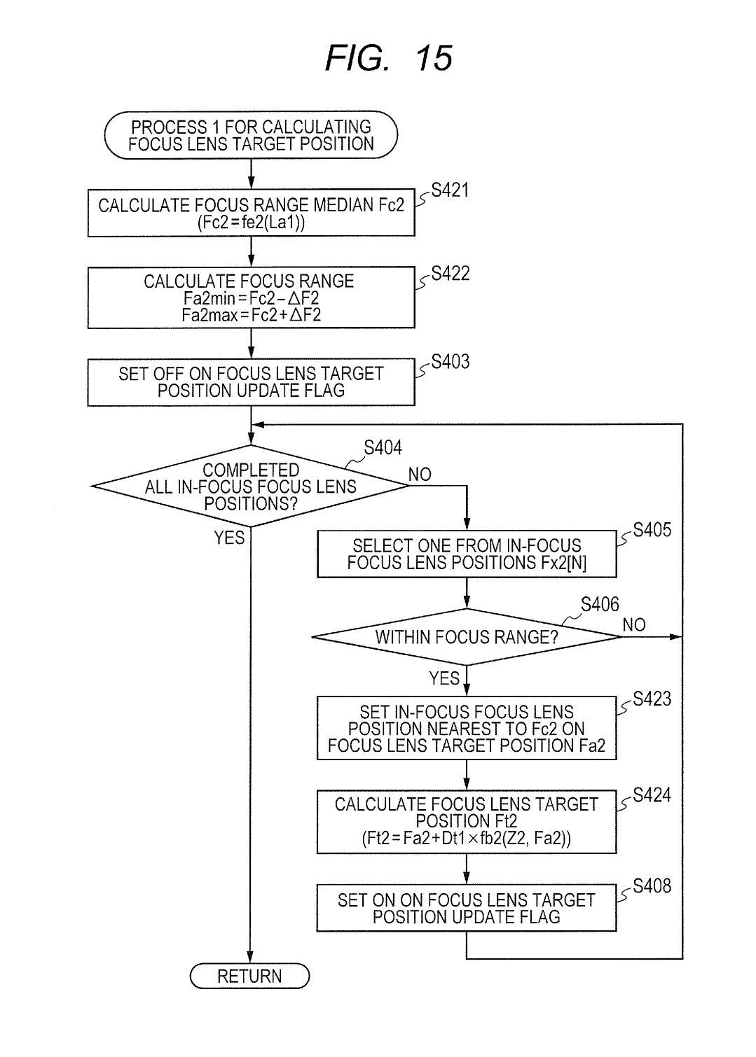

FIG. 15 is a flow chart of the focus lens target position calculation process 2. In step S421, a focus range median Fc2 is calculated from the reference object distance La1 obtained from the zoom lens apparatus 10 in step S321. The calculation fe2(x) using a lookup table used in this calculation is the same as that used in step S308 by which an object distance is converted to a focus lens position corresponding to the object distance.

In step S422, a smallest value Fa2min and a largest value Fa2max that define a range of ±ΔF2 from a center at Fc2 (the focus range) are set in the same manner as step S402 in FIG. 9.

The process in steps S403 to S406 is the same as that in the flow chart of FIG. 9 in the first embodiment. In steps S403 to S406, an in-focus focus lens positions in the predetermined focus range are selected from the in-focus focus lens position group Fx2[N] (the second in-focus information). Then, in step S423, the in-focus focus lens position nearest to the focus range median Fc2 among the selected in-focus focus lens positions is set as a focus lens reference position Fa2 (the second focus lens reference position). In the case where the number of selected in-focus focus lens positions is one, the one in-focus focus lens position is set as a focus lens reference position Fa2. In step S424, a focus lens target position Ft2 (the second focus lens target position) is calculated using the focus lens reference position Fa2 set in step S423 and the defocus amount Dt1 received from the zoom lens apparatus 10 in step S321 according to the following equation:

Ft2=Fa2+Dt1×fb2(Z2,Fa2),

where the calculation using the lookup table fb2(Z2, Fa2) used in step S106 for converting a defocus amount to a difference in the focus lens position is used. In other words, the focus lens target position Ft2 is set at a position displaced from the focus lens reference position Fa2 by a difference in the focus lens position corresponding to the defocus amount Dt1. Then, in step S408, the focus lens target position update flag is set to ON, and the process returns to step S404. After the above-described same process has been performed for all the in-focus focus lens positions included in the in-focus focus lens position group Fx2[N], the process is terminated.

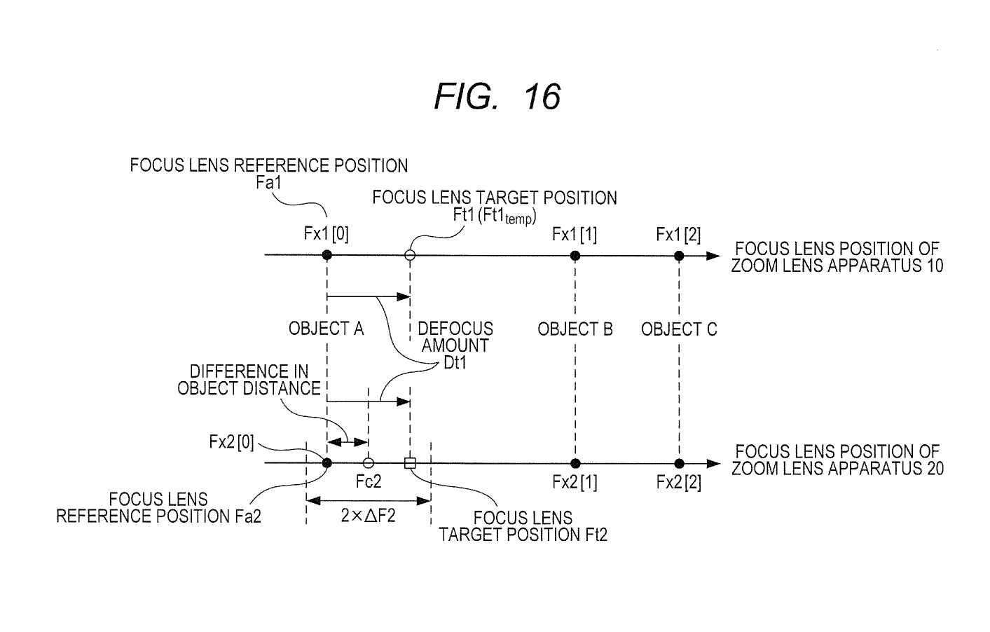

The operation and advantageous effects of the apparatus according to the second embodiment will be specifically described with reference to FIG. 16. As with in the first embodiment, it is assumed that the zoom lens apparatus 10 (the first lens apparatus) and the zoom lens apparatus 20 (the second lens apparatus) are used to take an image of three objects, which are referred to as object A, object B, and object C in order from the shorter object distance, the object A being the closest. It is also assumed that there is a difference between the object distance estimated by the zoom lens apparatus 10 and the object distance estimated by the zoom lens apparatus 20.

Firstly, the zoom lens apparatus 10 obtains the focus operation position data of the focus operating member 301 of the focus demand 30 (S221) and calculates a focus lens temporal target position Ft1ₜₑₘₚ (S205, S223). Then, the zoom lens apparatus 10 sets the in-focus focus lens position Fx1[0] nearest to the focus lens temporal target position Ft1ₜₑₘₚ as the focus lens reference position Fa1 (the first focus lens reference position), and calculates a defocus amount Dt1 corresponding to the difference in the focus lens position between the focus lens reference position Fa1 and the focus lens temporal target position Ft1ₜₑₘₚ (S224). Then, the zoom lens apparatus 10 transmits a reference object distance La1 (the information corresponding to the first focus lens reference position) obtained by converting the focus lens reference position Fa1 into an object distance and the defocus amount Dt1 to the zoom lens apparatus 20 (S208).

The zoom lens apparatus 20 converts the reference object distance La1 received from the zoom lens apparatus 10 into a focus lens position and calculates a focus range median Fc2 (S421). Then, the zoom lens apparatus 20 selects an in-focus focus lens position Fx2[0] within the range of ±ΔF2 from the focus range median Fc2 (or within the focus range) from the in-focus focus lens position group Fx2[N] (the second in-focus information) and set it as a focus lens reference position Fa2 (the second focus lens reference position) (S423). Lastly, the zoom lens apparatus 20 drives the focus lens targeting a focus lens target position Ft2 (the second focus lens target position) set as a focus position displaced from the focus lens reference position Fa2 by the defocus amount Dt1 received from the zoom lens apparatus 10 (S424).

By performing the above-described process in the second embodiment, the object distances of the two zoom lens apparatuses can be made equal to each other even at focus positions at which no object is in focus. Therefore, even during manual focusing operation by a user, an object will come in focus accurately and simultaneously in the two zoom lens apparatuses, and a natural 3D image with which a viewer does not feel anything strange can be picked up.

While preferred embodiments of the present invention have been described, it is to be understood that invention is not limited to the embodiments. Various modifications and changes can be made thereto within the essential scope of the present invention.

In the first embodiment, a focus lens target object distance Lt1 (the information corresponding to the first focus lens target position) obtained by converting a focus lens temporal target position Ft1ₜₑₘₚ into an object distance is transmitted from the zoom lens apparatus 10 (the first lens apparatus) to the zoom lens apparatus 20 (the second lens apparatus) and used in a process performed in the zoom lens apparatus 20. However, in cases where the zoom lens apparatus 10 and the zoom lens apparatus 20 are of the same model, the focus lens temporal target position Ft1ₜₑₘₚ (the first focus lens target position) itself may be transmitted for use in a process performed in the second zoom lens apparatus 20.

In the second embodiment, a reference object distance La1 (the information corresponding to the first focus lens reference position) obtained by converting a focus lens reference position Fa1 into an object distance is transmitted from the zoom lens apparatus 10 to the zoom lens apparatus 20 and used in a process in the zoom lens apparatus 20. However, in cases where the zoom lens apparatus 10 and the zoom lens apparatus 20 are of the same model, the focus lens reference position Fa1 (the first focus lens reference position) itself may be transmitted for use in a process performed in the second zoom lens apparatus 20.

In cases where the zoom lens apparatus 10 and the zoom lens apparatus 20 are of different models, because there are differences in the format of information representing the focus lens temporal target position and the focus lens reference position, a value converted into an object distance is transmitted as information not depending on the format. However, in cases where the zoom lens apparatus 10 and the zoom lens apparatus 20 are of the same model, they use the same format, and therefore there arise no problems in using information depending on the format in the process performed in the zoom lens apparatus 20.

In the first embodiment, an object distance (i.e. a focus lens target object distance Lt1) is used as the information corresponding to the first focus lens target position. However, information other than the object distance may be used instead as long as the information does not depend on the format of the information representing the focus lens target position in the zoom lens apparatus.

In the second embodiment, an object distance (i.e. a reference object distance La1) is used as the information corresponding to the first focus lens target position. However, information other than the object distance may be used instead as long as the information does not depend on the format of the information representing the focus lens target position in the zoom lens apparatus.

In Embodiments 1 and 2, the difference between the present position of the focus lens and the position of the focus lens in an in-focus state is used as the defocus amount. However, the defocus amount is not necessarily limited to this. For example, the difference between the distance between the peaks of present two images and the distance between the peaks of two images in an in-focus state in the phase difference sensor can be used as the defocus amount. The difference between the distance to an object and the in-focus object distance in an field angle can be also used as the defocus amount. While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-160727, filed on Jul. 19, 2012, which is hereby incorporated by reference herein in its entirety.

What is claimed is:

1. An optical apparatus comprising:
a first lens apparatus having a first focus lens, a first focus driving unit that drives the first focus lens, a first in-focus state detecting unit that detects first in-focus information of one or more objects by phase difference detection method, and a first focus controller that controls driving of the first focus lens; and
a second lens apparatus having a second focus lens, a second focus driving unit that drives the second focus lens, a second in-focus state detecting unit that detects second in-focus information of one or more objects by phase difference detection method, and a second focus controller that controls driving of the second focus lens,
wherein in the first lens apparatus, the first focus controller sets a first focus lens target position on the basis of the first in-focus information detected by the first in-focus state detecting unit and drives the first focus lens on the basis of the first focus lens target position, and
in the second lens apparatus, the second focus controller obtains the first focus lens target position or information corresponding to the first focus lens target position from the first lens apparatus, sets a focus range on the basis of the first focus lens target position or the information corresponding to the first focus lens target position, and drives the second focus lens on the basis of the focus range and the second in-focus information detected by the second in-focus state detecting unit.

2. An optical apparatus comprising:
a first lens apparatus having a first focus lens, a first focus driving unit that drives the first focus lens, a first in-focus state detecting unit that detects first in-focus information of one or more objects by phase difference detection method, and a first focus controller that controls driving of the first focus lens; and
a second lens apparatus having a second focus lens, a second focus driving unit that drives the second focus lens, a second in-focus state detecting unit that detects second in-focus information of one or more objects by phase difference detection method, and a second focus controller that controls driving of the second focus lens,
wherein in the first lens apparatus, the first focus controller drives the first focus lens on the basis of a given first focus lens target position, and
in the second lens apparatus, the second focus controller obtains, from the first lens apparatus, the first in-focus information detected by the first in-focus state detecting unit and a first focus lens reference position based on the first focus lens target position or information corresponding to the first focus lens reference position, obtains a defocus amount of the first focus lens target position relative to the first focus lens reference position, sets a focus range on the basis of the first focus lens reference position or the information corresponding to the first focus lens reference position, and drives the second focus lens on the basis of the focus range, the second in-focus information detected by the second in-focus state detecting unit, and the defocus amount.

3. An optical apparatus according to claim 1, further comprising a focus sensitivity calculating unit that calculates a focus sensitivity representing an out-of-focus amount resulting from a predetermined amount of deviation of the focus lens position from an in-focus focus lens position, wherein when the calculated focus sensitivity is lower than a predetermined value, the second focus controller drives the second focus lens on the basis of the first focus lens target position of the first lens apparatus.

4. An optical apparatus according to claim 1, wherein the second focus controller of the second lens apparatus obtains, from the first lens apparatus, driving speed of the first focus lens driven to the first focus lens target position and drives the second focus lens at that driving speed.

5. An optical apparatus according to claim 1, wherein the second focus controller of the second lens apparatus obtains, from the first lens apparatus, driving time taken for the first focus lens to be driven to the first focus lens target position, calculates driving speed of the first focus lens driven to the first focus lens target position on the basis of the driving time, and drives the second focus lens at that driving speed.

6. An optical apparatus according to claim 1, wherein the information corresponding to the first focus lens target position comprises information about the distance from the first lens apparatus to an object that is in focus at the first focus lens target position.

7. An optical apparatus according to claim 2, wherein the information corresponding to the first focus lens target position comprises information about the distance from the first lens apparatus to an object that is in focus at the first focus lens reference position.
